(19) United States
(12) Patent Application Publication
(10) Pub. No.: US 2001/0053980 A1
(43) Pub. Date: Dec. 20, 2001

(54) Method and system for blind electronic warranty registration

(76) Inventors: Douglas M. Suliman JR., Sherborn, MA (US); Eric L. Weiss, Waltham, MA (US); Aldo F. Castaneda, Medfield, MA (US)

Correspondence Address: STROOCK & STROOCK & LAVAN LLP, 180 Maiden Lane, New York, NY, 10038, US

(21) Appl. No.: 09/738,664

(22) Filed: Dec. 15, 2000

Related U.S. Application Data
(60) Provisional application No. 60/172,351, filed on Dec. 16, 1999.

(51) Int. Cl. G06F 17/60

(52) U.S. Cl. 705/1

(57) ABSTRACT

This invention relates to the field of data collection and utilization and, in particular, to a method and system for the electronic collection and utilization of product warranty registration information. A registration system and method centrally receives product registration information and communicates the information to third parties with associated consumer identifiers stripped of all personal consumer information to provided a secure and confidential way to register products and gain the maximum support and service from manufacturers and service providers. The registration system may also be linked to external product information sources to provide product notices, such as recall and safety notices, to consumers.

This Application claims priority to U.S. Provisional Application Ser. No. 60/172,351, filed on Dec. 16, 1999.

### FIELD OF THE INVENTION

This invention relates to the field of data collection and utilization and, in particular, to a method and system for the electronic collection and utilization of product warranty registration information.

### BACKGROUND OF THE INVENTION

Under certain laws, manufacturers are required to provide a warranty for the products they sell to consumers. To best serve the consumer, manufacturers often request that the consumer register the product with the manufacturer by way of a return postcard. These postcards request information such as model number, serial number, date of purchase, and point of purchase necessary to identify the goods. The post card usually also requests personal information, such as, name and address of the purchaser or end user to connect the goods to the interested party. Additionally, many manufacturers use the return of these postcards to obtain not only personal information such as name and address of their consumers, but demographic information to help them in their marketing and research and development efforts. In practice, this information is commonly gathered by third parties on behalf of manufacturers and at no cost to the manufacturers. These third parties profit from the sale of the gathered consumer data.

Because the warranty registration cards are used as questionnaires which ask many personal information questions and demographic questions about the product user, many users consider this an invasion of privacy. They also consider filling out such cards an inconvenience and wasteful use of their time. As a result, consumers are reluctant to register their products. The number of returned registration cards in the U.S. for example is less than 10% of all purchased products. Thus, manufacturers cannot properly track their sold products to the ultimate purchaser. Consequently, product end users cut themselves off from the company so that they may not receive information such as recall information or product enhancement information from the manufacturer. Accordingly, the manufacturer is hampered in its ability to service the consumer and the consumer is hampered in his or her ability to enjoy the full benefits of ownership of a product from particular manufacturers.

In today's e-commerce environment, manufacturers are also increasingly selling their products online. Manufacturers, at time of purchase, or even prior to purchase, such as during a web site browsing session, often ask for similar personal information from their consumers and prospective consumers to either register the products with the company or to learn about their potential consumers. Online purchasers are even more hesitant to provide such information online to manufacturers, because in addition to all of the concerns with the prior art warranty cards, there are the added concerns that the manufacturer will turn around and sell the gathered consumer information (as is customary in e-commerce), that an unauthorized hacker will obtain this personal information, or even if the information remains with the manufacturer, that the manufacturer will “spam” the consumer with unwanted e-mail.

In addition to the shortcomings in current consumer product information collection methods, there are presently no efficient means for providing manufacturer product information, such as product recalls, safety notices, updates, rebates, and the like, to consumers who have registered their products. Presently, product recall and safety information in the U.S. is collected by national agencies who post the information. The U.S. Consumer Product Safety Commission (“CPSC”) and U.S. National Highway Traffic Safety Administration (“NHTSA”) are such agencies. However, many consumers are either unaware of the CPSC and NHTSA or do not bother to periodically check their databases. Thus, much of this valuable and potentially life saving information goes untapped by the purchasing public.

Moreover, presently there are no services that track the history of a consumer product so that consumers can efficiently sell used products in a secondary market. Buyers of used products often have no way of knowing whether a particular product has a known defect, been recalled or been repeatedly serviced. These uncertainties thus provide a chilling effect on secondary markets for used consumer products.

Accordingly, it is desired to fill the void in the prior art to provide a method and system which simplifies and automates the collection of consumer and product information while protecting the privacy of the consumer, allows the manufacturer to properly service the consumer and track the goods sold by the manufacturer, and encourages the consumer to register products in a way accessible and usable by the manufacturer.

Moreover, it is also desired to fill the void in the prior art to provide a method and system that provides consumer access to product recall and safety notices, tracks the service and repair history of particular consumer products, and provides efficient access to secondary markets.

### SUMMARY OF THE INVENTION

The system of the present invention provides for collecting and tracking consumer products and generally comprises a registration system preferably interconnected via a computer network to a plurality of consumers and a plurality of manufacturers, the registration system receiving consumer and product data from the plurality of consumers and assigning a consumer identifier to the consumer and product data for each of the consumers. The registration system communicates product information and associated consumer identifiers to the plurality of manufacturers so that the manufacturers can service the products identified in the product information. Because the consumer identifier is stripped of all personal consumer information, consumers are provided a secure and confidential way to register their products and gain the maximum support and service from the manufacturer. In return, manufacturers capture more product registrations and can implement profitable one-to-one communication strategies to support their existing product distribution channels. As used herein, personal information refers to that information which could personally identify a consumer, including but not limited to name, address, telephone numbers, social security numbers, and the like.

The registration system generally includes one or more servers, including data processors and databases for storing consumer and product information. The registration system is interconnected to a global communications network to permit limited access to the registration system by consumers, manufacturers, and other service organizations that may be integrated from time to time into the system. As used herein, the term “global communications network” refers to any globally accessible communications network, such as for example the World Wide Web, a wireless network, Personal Communication Systems (“PCS”), satellite, or any other communications network, including point-to-point dial-up. One skilled in the art, of course, will recognize that the present invention can operate over any communications network in which data can be transmitted between consumers and the registration system and, in turn, between the manufacturers and other service organizations. Use of the present invention over the World Wide Web, whether accessed over phone lines, cable lines, or satellite or other wireless transmission mediums, is preferable, because the registration system can more efficiently serve a plurality of consumers and manufacturers.

In use, the registration system receives consumer and product information either at the point of purchase or later as entered by the consumer. For instance, using standard UPC bar-codes or other product identifiers, a consumer can scan the bar-code using a handheld device at the time of purchase to store the product information. In another embodiment, known radio frequency identification (RFID) techniques utilizing so-called “electronic tags”, such as Motorola's BiStatix chips (described in “Developers pitch RFID system as bar code replacement”, by Charles J. Murray, Nov. 2, 2000, EETimes.com) or other passive or active transponder technology known in the art could be employed to store and transfer product information to a consumer device for instantaneous or time-delayed later transfer to the registration system. Smart cards, such as by way of non-limiting example credit cards having imbedded chip systems, could also be utilized to capture and transfer product data to the registration system. The consumer, after setting up an account with the registration system, can upload the product information to the registration system. Of course, the product information can also be uploaded at the time of purchase. The consumer's unique identifier is mapped to the uploaded product information by the registration system. At this point, the product information along with the consumer identifier can be passed to the manufacturer to register the product. The registration system further accesses product recall and safety services to provide real-time or near real-time recall and safety information to the consumer.

Recall, safety or other product specific notices can be simply and efficiently communicated to consumers by linking the product registrations and consumer identifiers of the consumers who have purchased and registered the subject products on the registration system. The registration system then communicates the notice to the appropriate consumers. In this way, the consumers are supplied valuable information from the manufacturer without compromising their personal information.

The registration system may also be linked to service organizations that provide maintenance and repair services for consumer products. Consumers can schedule repairs and maintenance for their registered products with local service organizations at the touch of a button. In return, service organizations gain the unique marketing benefit of aggregated consumer demand for repair service at a centralized and directly linked location.

The registration system can also track the service history for each registered product providing valuable benefits to the consumer, the manufacturer, and consumers in the secondary markets. For example, manufacturers can access the service history of their products to evaluate whether certain repairs are recurring. Thus, manufacturers can tap a centralized source of product service information previously unavailable. Consumers also benefit because the service and repair history of their products can be verified by buyers in secondary markets, thereby alleviating some of the fears of buyers of used products.

Other objects and features of the present invention will become apparent from the following detailed description, considered in conjunction with the accompanying drawing figures. It is to be understood, however, that the drawings, which are not to scale, are designed solely for the purpose of illustration and not as a definition of the limits of the invention, for which reference should be made to the appended claims.

### BRIEF DESCRIPTION OF THE DRAWING FIGURES

In the drawing figures, which are not to scale, and which are merely illustrative, and wherein like reference numerals depict like elements throughout the several views:

FIG. 1 is a schematic diagram of an overview of the registration system in accordance with a preferred embodiment of the present invention;

FIG. 2 is a schematic diagram of an illustrative server system of the registration system of FIG. 1;

FIG. 3 is a diagram of exemplary data flow between consumers, manufacturers, external databases and the registration system of FIG. 1;

FIG. 4 is a screen shot of a web page initiating creation of a consumer account in accordance with a preferred embodiment of the present invention;

FIG. 5 is a screen shot of a first product registration web page in accordance with a preferred embodiment of the present invention;

FIG. 6 is a screen shot of the product registration page of FIG. 5 depicted a drop down menu in accordance with a preferred embodiment of the present invention;

FIG. 7 is a screen shot of a second product registration web page in accordance with a preferred embodiment of the present invention;

FIG. 8 is a screen shot of an account summary web page in accordance with a preferred embodiment of the present invention; and

FIG. 9 is a screen shot of an account summary web page offering links to secondary market systems in accordance with a preferred embodiment of the present invention.

### DETAILED DESCRIPTION OF THE PREFERRED EMBODIMENTS

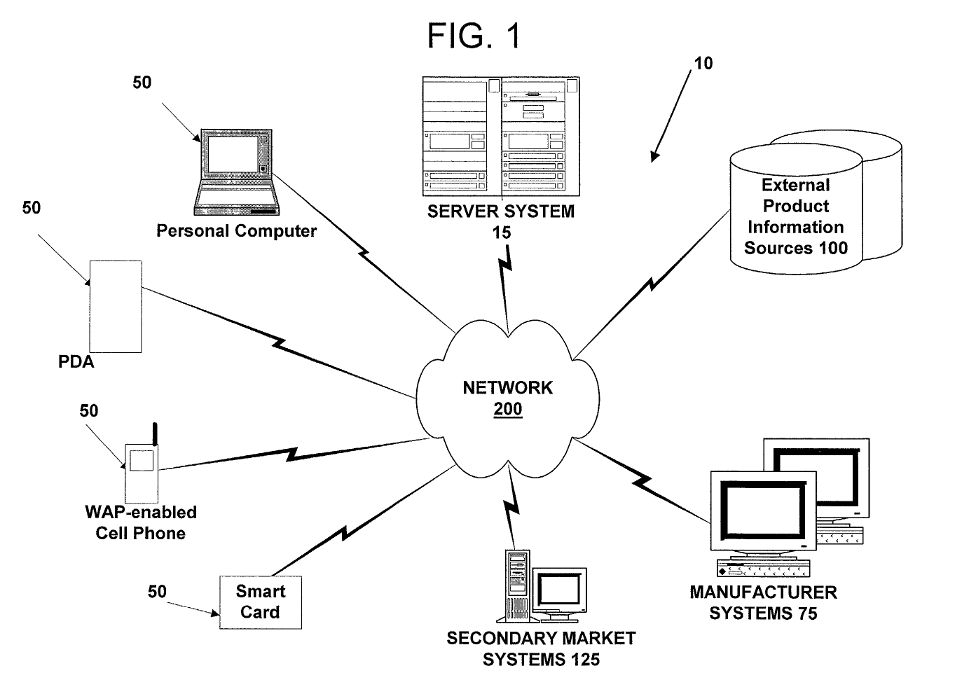

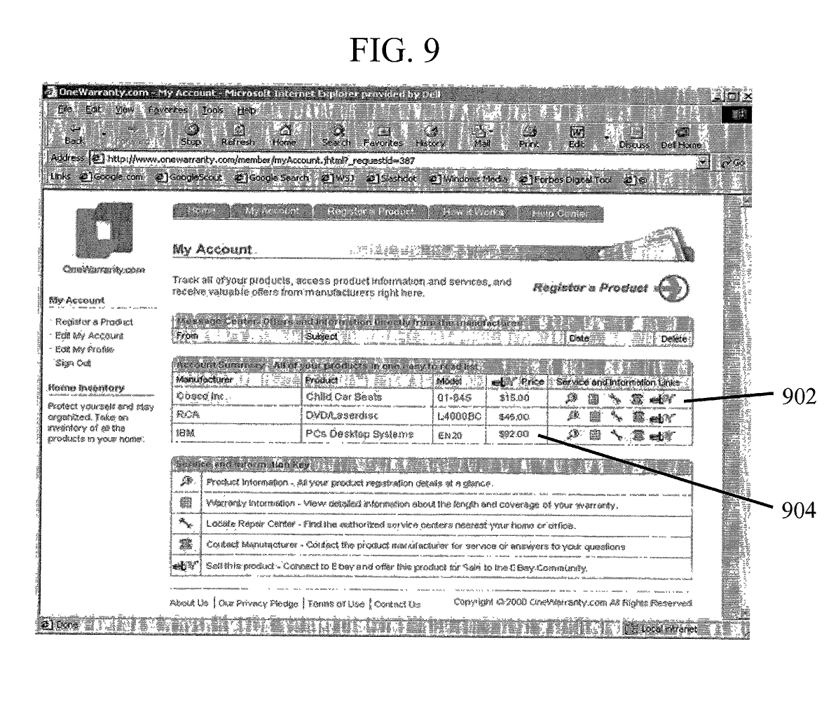

With reference to FIGS. 1-9, the present invention is directed to a centralized registration system 10 for the storing of consumer product registrations in a way that benefits both manufacturers and consumers. The system and method according to the present invention permits the anonymous registration of consumer products with a centralized registration system 10 to increase registrations and to provide a mechanism for the communication of product registrations to manufactures and, in turn, product information from manufacturers to consumers without revealing the consumer's identity. Further, the present invention provides a real-time link to consumer safety and other external product information sources 100 to provide consumers with real-time information regarding the products they own. Yet further, the present invention provides links to repair, maintenance and secondary market systems 125 to offer the consumer the full range of benefits from ownership of a consumer product. As will be seen from the following detailed description, the present invention provides many advantageous features over existing consumer product registration and information collection systems and methods.

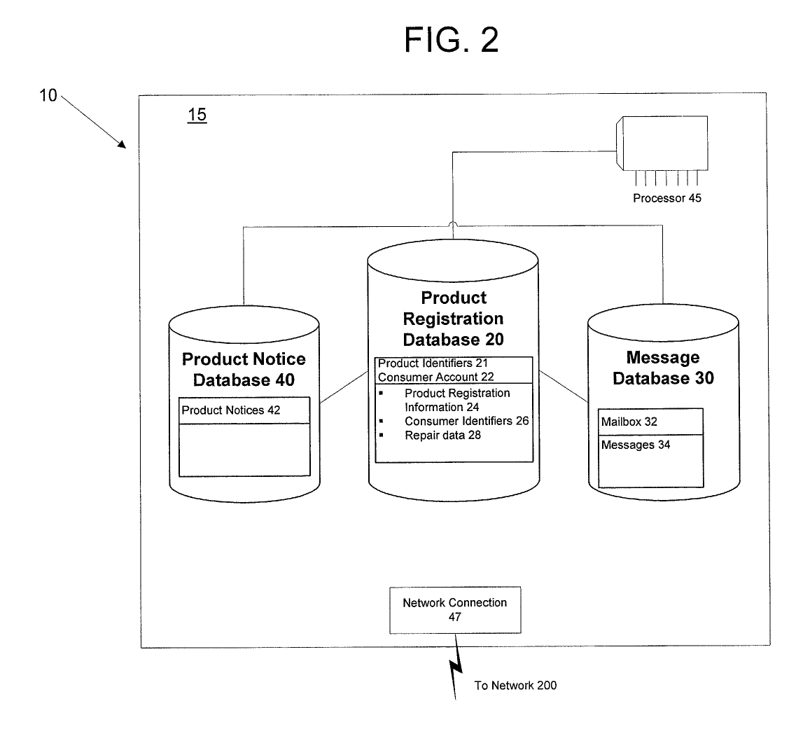

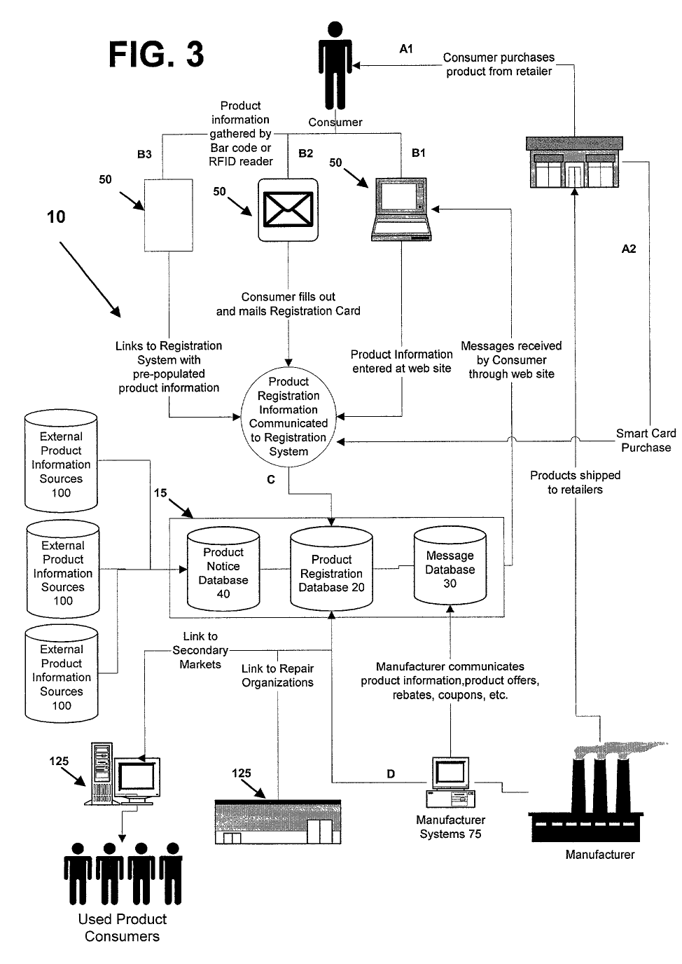

Generally speaking, and referring to FIGS. 2 and 3, a method of anonymously collecting product registration information from a consumer for a purchased product, comprises receiving the product registration information 24 along with a consumer identifier 26 into a registration system; storing the product registration information 24 in a customer account 22 associated with the consumer identifier 26, communicating the product registration information 24 along with the consumer identifier 26 to a manufacturer of the product; receiving one or more messages 34 from the manufacturer regarding the product to into a mailbox 32 associated with the consumer identifier 26, such that the consumer can retrieve the messages 34 without revealing the consumer's identity to the manufacturer.

With reference to FIGS. 1 and 2, a registration system 10 according to the present invention that facilitates the collection of consumer product information and communication of product information between manufacturers and consumers using a client server architecture generally comprises a server 15 interconnected to a plurality of consumer devices 50, the server 15 including a product registration database 20 for receiving and storing product registration information 24 communicated by the consumers, and a message database 30 for receiving messages communicated by the manufacturers regarding a product registered by the consumer. The server 15 further comprises a product notice database 40 for receiving product notices 42 from external product information sources 100, whereby the server 15 matches the product notices 42 to the product registration information 24 stored in the first database 20 and notifies each consumer of product notices 42 matching the product that has been registered. Other features of the registration system will become apparent from the following.

A consumer may include any person who has registered with the registration system 10 by providing certain personal information, as described further below, and who from time to time purchases consumer products. A consumer product is any tangible or intangible product or service that is obtainable, or available for purchase, barter or otherwise, by a consumer, including but not limited to electronics, home appliances, automobiles and accessories, sporting goods, and children's toys, to name a few.

A manufacturer is any manufacturer, dealer or seller or other provider, by an means known or hereinafter known, of a consumer product as described above. Each manufacturer produces goods in the normal course of business and sells these goods to consumers. It is irrelevant whether consumers purchase the products directly or indirectly from manufacturers through conventional store outlets or through e-commerce over the World Wide Web. One skilled in the art of the present invention will recognize that although the registration system 10 is being described in connection with manufacturers, product registration information can be communicated in an anonymous fashion according to the present invention to any third party desiring such information.

System Architecture

With reference to FIGS. 1 and 2, an overview of the system architecture of the present invention will now be described.

In the contemplated invention, a registration system 10 allows the registration of consumer products in a centralized, anonymous fashion relative to third parties, such as product manufacturers, to track the products purchased by consumers. Registration system 10 includes a server 15 and is interconnected to a plurality of consumer devices 50, manufacturer systems 75, external product information sources 100, and secondary market systems 125 through a global communications network 200. In this way, registration system 10 can receive product registration information 24 from consumers and product information from manufacturers systems 75 and information from external sources 125.

In a preferred embodiment, the server 15 of the registration system 10 generally includes a product registration database 20, a message database 30, a product notice database 40, a processor 45, and a network connection 47. Although not depicted in the figures, server 10 also generally includes such other art recognized components as are ordinarily found in server systems, including but not limited to RAM, ROM, clocks, hardware drivers, and the like.

Network connection 47 is a gateway interface to network 200 through which registration system 10 can communicate with a plurality of consumer devices 50, as shown in FIG. 1. Network connection 47 may connect to network 200 through use of a conventional modem (at any known or later developed baud rate), an open line connection (e.g., digital subscriber lines or cable connections), satellite receivers/transmitters, wireless communication receivers/transmitters, or any other network connection device as known in the art now or in the future.

Through communication with consumer devices 50, the server 15 collects and stores the product registration information 24 in the product registration database 20 for the consumer products purchased and registered by consumers. As will be described further below, when a consumer registers with the registration system 10, a consumer account 22 is created. Included in the consumer account 22 is basic consumer information including, at the very least, a name, electronic address, password and unique consumer identifier 26 for the consumer. In an alternate preferred embodiment, described below, the postal address for consumers could be requested to permit a consumer to “opt-in” to receive communications directly from manufacturers. The consumer account 22 is stored in the product registration database 20. A consumer account 22 is created for each consumer to store the product information for the consumer products purchased by that particular consumer. The consumer account stores information regarding consumer products including, but not limited to, product category, product line, manufacturer, make or model, date of purchase, serial number, and the length of any warranties on the product. In addition, optional information such as price, payment method, place of purchase, and other similar information can be stored. The consumer account 22 is identified by the consumer's unique identifier 26 stored therein, and is accessible only by that consumer using a user id and password. The user id may, for example, be the e-mail address of the consumer.

The server 15 of registration system 10 also preferably includes a product notice database 40. The product notice database 40 stores product notices 42 such as recall notices, safety notices, product updates, and other information from external sources, to name a few. The product notice database 40 is electronically linked to recall and safety databases 100, such as the CPSC and the National Highway Traffic Safety Administration (“NHTSA”). As the CPSC and NHTSA receive new notices 42 regarding consumer products, the database 40 is updated and the new notices 42 are collected and stored in the product notice database 40. As will be described further below, the notices 42 in the notice database 40 are compared and matched to the products stored in the consumer accounts 22 in the product registration database 20. In this way, consumers can be notified of safety and recall notices 42 for consumer products on a real-time basis.

Registration system 10 also includes a message database 30 for communicating electronic messages 34 regarding consumer products to the consumers. Manufacturers can communicate messages 34 to the message database 30 for retrieval by the consumer. In this way, consumers can receive messages in two ways: (1) the consumer can log on to his or her consumer account 22 on the product registration database 20 and check whether any messages 34 have been posted to their mailbox 32 on the message database 30 for the products they own; or (2) the consumer can receive electronically communicated messages 34 directly to their personal e-mail account from the message database 30.

Furthermore, the message database 30 can be utilized to notify consumers of product recalls or safety notices. For instance, if a product registered by a consumer is subject to a newly issued recall notice, the product registration database 20 will forward that message to the message database 30, which will in turn communicate the message to the consumer's e-mail address to notify the consumer of the recall notice or hold the message for retrieval by the consumer.

One skilled in the art will recognize that the registration system 10 may as a matter of design choice include any number and configurations of servers 15, which may be used separately or in tandem to support the traffic and processing needs necessary in operation at one time.

Consumer device 50 preferably includes, by way of non-limiting example, a storage device, processor, display device, input device, and network connection (not shown). In general, consumer device 50 is a personal computer or net appliance capable of accessing and interacting with the registration system 10 and a particular consumer account through network 200. In addition, a consumer device 50 can be any other portable communication device such as a PDA, wireless or wired telephone, smart card and other hand-held computing devices. Consumer device 50 also includes such other components as are ordinarily found in such systems, including but not limited to RAM, ROM, clocks, hardware drivers, software and the like. It should be noted that a consumer may utilize any number of consumer devices 50 to interact and communicate with the registration system 10. For instance, a consumer might access his/her account using a PC and communicate product registration information using a WAP enabled PDA, as described below.

Furthermore, the consumer device 50 could include a scanning mechanism to scan bar-codes or some other optical product identifier associated with the consumer products. For example, the consumer while in a store can scan or access product information, including the product identifiers, embodied in a bar-code or stored on a device located at the store through a scanning device, the Wireless Application Protocol (WAP), a wireless short-range radio technology, such as a bluetooth device, or through infrared data transmission to make selections electronically. As mentioned, the consumer device 50 may be, for example, a wireless portable device such as a wireless telephone or personal digital assistant (PDA).

Yet further, consumer device 50 could be a device adapted to receive radio frequency transmissions from an electronic tag in a process commonly referred to as Radio Frequency Identification (RFID). In such a system, the RFID consumer device 50 would read product information from an electronic tag emitting rf signals. The tags are programmed with product information, including but not limited to model, make, and serial number.

Still further, a consumer can use a smart card device 50, such as a smart card enabled credit card, that is capable of storing and operating software that could capture product information at the point-of-purchase. The product information could be communicated directly from the point-of-purchase to the registration system 10 via a credit card network, through the credit card provider's bill processing system, or after download to another consumer device 50, such as the consumer's PC or WAP-enabled PDA or cell phone.

Additionally, touch tone entries, or touch tone speech response, or voice capture techniques might be used.

While various preferred methods of communicating data to the registration system have been described, one skilled in the art will recognize that any method of data capture could be employed despite not being mentioned herein or heretofore developed.

Once product information is collected it may be electronically communicated to the registration system 10 through network 200. Network 200 is any global communications network, such as the World Wide Web, a wireless network, Personal Communication Systems (“PCS”), satellite, the public switched telephone network, or any other communications network, such as point-to-point protocol or other direct dial-up connection. One skilled in the art, of course, will recognize that the present invention can operate over any communications network in which data can be transmitted between registration system 10, consumer device 50, manufacturer devices 75 and other various information sources 100. Use of the present invention over the World Wide Web or other global public network is preferable, but not essential, because the registration system 10 can more efficiently serve a plurality of consumers.

Centralized Product Registration

With reference to FIGS. 1-9, a preferred embodiment of the process of centralizing product registration by creating consumer accounts 22 and registering consumer products will now be described. The centralized product registration system 10 offers consumers anonymous product registration, while facilitating the collection and transfer of various forms of product information.

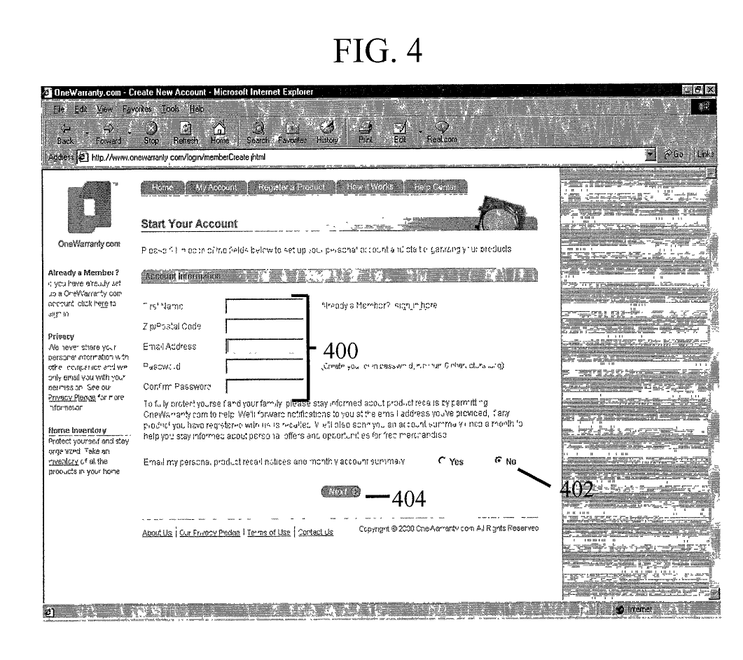

New users of the registration system 10 first setup a consumer account 22 in which the consumer's registered products are stored and can be tracked by the registration system 10. In a preferred embodiment, the consumer registers and creates an account by logging onto and interacting with the server 15 of the registration system 10 via network 200, such as the World Wide Web. In a preferred embodiment of an online web form, shown in FIG. 4, the registration system 10 prompts the consumer using form 400 for, at least, the consumer's first name, zip code, and an electronic address (such as an e-mail address). The registration system 10 also prompts the consumer for a password to protect access to the consumer account 22. The consumer may also select whether to receive e-mailed product information directly by clicking an option field 402.

Once this information is entered and submitted by pressing, for example, the <<NEXT>> button 404, the registration system 10 creates a personalized consumer account 22 in the product registration database 20 in which the consumer products registered by the consumer will be stored and tracked. The consumer can now register products. One skilled in the art will recognize, however, that the system could be modified to require consumers to enter a product registration at the time of account set up.

According to the present invention and with further reference to FIG. 3, consumer products can be registered in any number of ways, including but not limited to traditional registration cards, web-site data communication, bar-code/RFID scanners, or smart cards.

A consumer having purchased a product and set up a consumer account 22 can register products by filling out the product registration card generally included in the product packaging. This card generally prompts the input of information traditionally found on such registration cards (product type, manufacturer, serial number, etc.) and further prompts consumers for the consumer identifier 26 to facilitate entry of the information to be stored in the consumer account 22. As is traditionally the case, the product registration card is mailed and the information is either manually input into the product registration database 20 or scanned in using known scanning methods. Product registration 24 is thus created 20 and stored in the consumer account 22 (FIG. 2). The product registration information 24 is stored as a data file within the consumer account 22 and is associated with a product identifier 21 corresponding to the make and model of product to which the product registration information 24 relates.

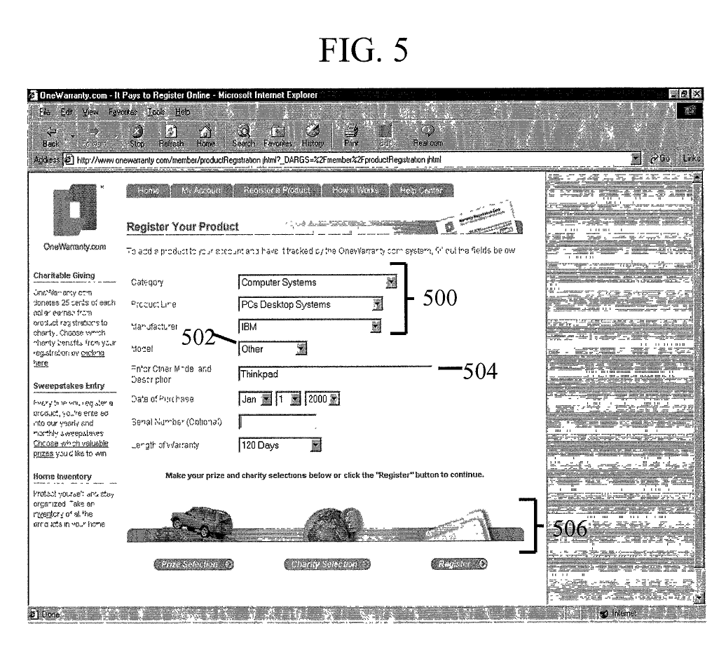

With further reference to FIGS. 5-8, product registration information can also be entered into the registration system 10 by logging into the consumer account 22 and filling out an on-line information sheet, whereby the information is electronically communicated and stored in the product registration database 20. In one version, the consumer selects choices from drop-down menus 500 to input information regarding product category, product line, manufacturer, model, date of purchase, serial number, and length of warranty, to name a few. Use of drop down menus 500 (as shown in FIG. 5) during product registration is preferable because it forces consumers to enter product data in a structured and predetermined fashion ensuring accurate product data. In situations where the product data has not been pre-determined, the consumer can enter data by selecting an “other” field 502. All data entered through use of the “other” field is checked for its validity using a “rationalization” process. During this process, the entered data is matched against known data for any given product to determine its accuracy.

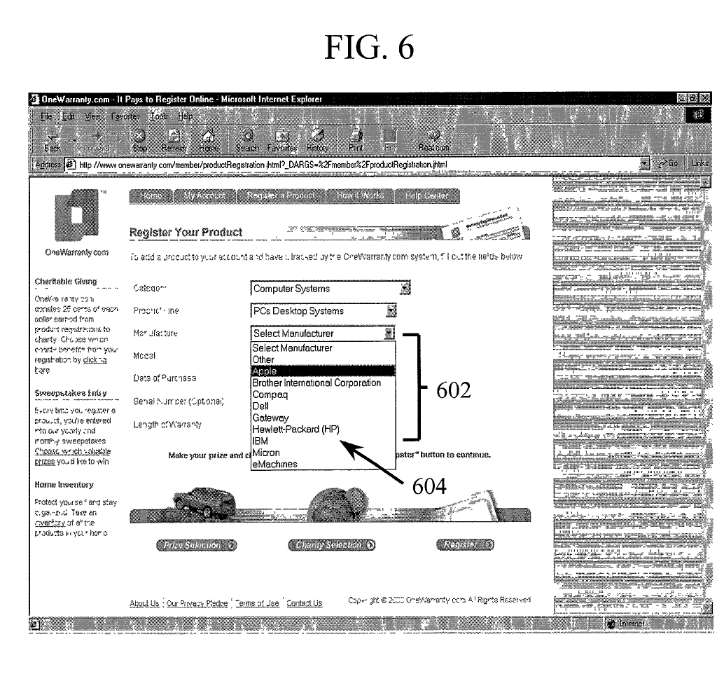

The rationalization process will now be described. As can be seen in FIGS. 2 and 6, the drop-down menus 602 from which the consumer selects the product information for a product to be registered is pre-populated with data 604 associated with that particular product. All of the data 604 associated with the particular make and model of a product is assigned a product identifier 21, which is stored in the product registration database 20. Thus, when a consumer selects from the pre-populated data 604 in the drop-down menus 602 and a product registration information 24 is created in the consumer account 22, that product registration information 24 is associated with the product identifier 21 for that particular product. In this way, any registration data being received by the registration system 10 or being communicated from the registration system 10 to third party systems, such as but not limited to manufacturer systems 75 and secondary market systems 125, can be efficiently transferred and identified by the product identifier 21.

In addition, the product identifier 21 serves to ensure accurate matching of recall and safety notices to product registrations information 24. In this process, product notices 42 are collected from external product information sources 100. The product notices 42 are generally embedded in a larger file received by the registration system 10. This larger file is programmatically parsed by the registration system 10 to find and separate the product notices 42. To do so, the registration system preferably searches for information that could be identified with a particular product. For example, the registration system 10 might search for a particular make and model of a product so that it could be matched to the pre-programmed product identifier 21. Once the file is parsed, all of the individual product notices 42 are mapped to the product identifier 21 associated with the particular product to which that notice pertains. Consequently, product notices 42 can be efficiently and accurately matched to product registration information 24. This process also facilitates communication of product registration information 24 and product notices 42.

As shown in FIG. 5, information can be also be input by using the “other” field 502. When a consumer chooses to use the other field 502, a text input box 504 allows the consumer to manually type in the product data (in the case of FIG. 5 a model description). Because it is preferable to store product registration information in a common data structure to facilitate communication, the data entered into the input field 504 must be verified before it is mapped to the product identifier 21. The inputted data is matched against known product data to determine its validity. If the product data is valid, then it is returned to the data structure for which it pertains, i.e., in the case of FIG. 5, the model field. Therefore, by assigning each product make and model a product identifier 21 and associating product notices 42 to the product identifier 21, the registration system 10 can programmatically link product registration information 24 with the recall and safety notices and generate manufacturer reports in an efficient and accurate manner.

The consumer may also be given the option to participate in product sweepstakes and donate to various charities. (See FIGS. 5-6 and description below) Upon completion, the consumer transmits the product data to the product registration database 20 and the product registration information 24 file is created.

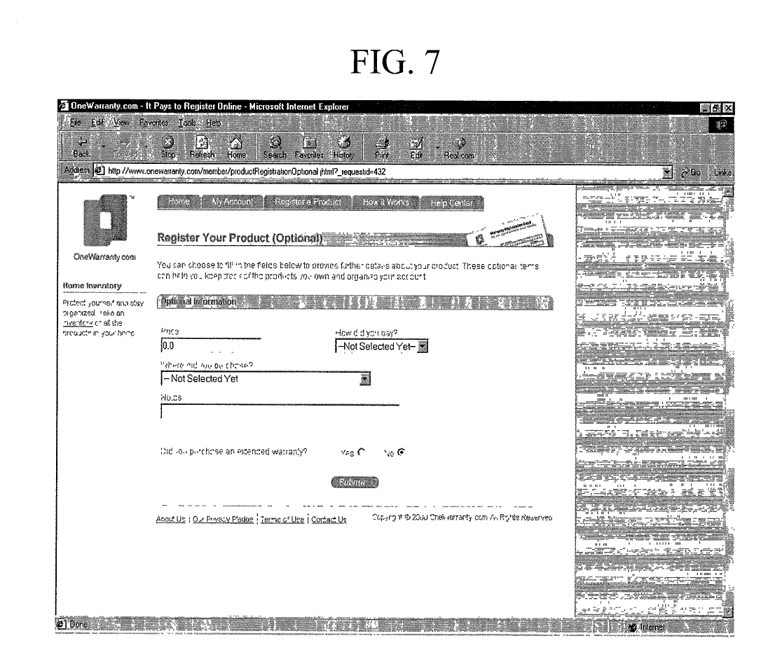

The consumer may then be given the opportunity, as shown in FIG. 7, to enter additional product information, including price, payment method, place of purchase, notes regarding purchase, and information regarding extended warranty or service contracts.

Referring back to FIG. 3, in another version of a preferred embodiment, a consumer device 50 is used to electronically receive the product information and communicate that product information to the product registration database 20. Bar-codes, such as the ubiquitous UPC bar-code, are embedded with information including manufacturer and product model data. Upon purchase of a consumer product, a consumer can scan the bar-code, thereby receiving this product information into their consumer device 50. This information, by way of example only, can be electronically communicated to the product registration database 20 and stored in their consumer account using a WAP enabled device. For instance, cellular phones or hand held electronic organizers (PDAs) are currently being produced that are WAP enabled and have the ability to scan bar-codes. A consumer who scans a product bar-code with a WAP enabled cell phone or PDA can then instantaneously (or at a later time) communicate the product information to the product registration database 20. In this way, all manual steps in the collection of product registration information are eliminated.

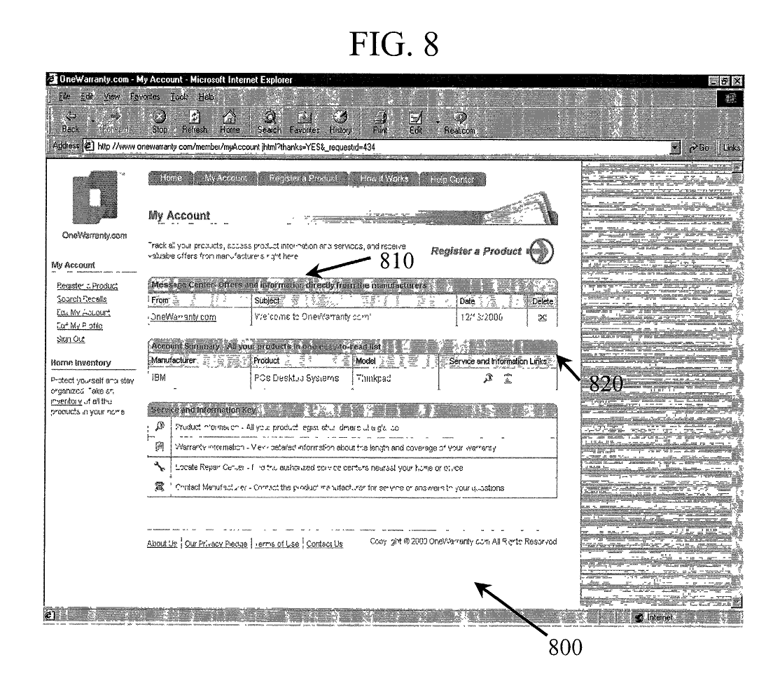

With reference now to FIG. 8, consumers can track and manage their registered products through network 200. The server 15 of the registration system 10 generates an account summary page 800 accessible through network 200. In a preferred embodiment, the account summary page 800 includes field 810 for viewing messages 34 communicated to the message database 30 which pertain to particular products or consumers. Through this communication mechanism, manufacturers can offer rebates, coupons, product incentives, or communicate product information, such as recall and safety notices (See FIG. 3). Because, as described above, manufacturers only receive a unique consumer identifier 26 (stripped of all personal information) from the registration system 10, the messaging process is entirely anonymous, unless the consumer has opted in to receive direct communications from the manufacturer. Of course, those skilled in the art will recognize that any type of product information may be communicated to the message database 30 and, in turn, passed onto the consumer's account summary page 800.

The account summary page 800 also preferably includes a product summary field 820 in which each of the product registration information 24 files are listed. From this field 820 consumers can access information, service, repair, secondary market and other product related links. For example, in a preferred embodiment, the registration system 10 is linked to secondary market systems 125 (FIGS. 1 and 3), such as auction sites, so that the consumer can place a particular product on sale. In addition, the registration system is linked to various service and repair organizations to offer the consumer repair and maintenance services. The product registration information 24 preferably is associated with repair data 28 in the product registration database 20 for particular products registered and stored in consumer accounts 22. Thus, when a consumer offers a product for sale on an auction site, for example, the product's repair data 28 can be posted for buyers to review. As described above, both the consumer and buyer benefit from this information exchange.

An exemplary illustration of a preferred embodiment of the present invention will now be described. (FIGS. 1-9) To register the product a consumer registers with a server 10 by utilizing a consumer device 50 such as a personal computer or other digital data communication device which can access the World Wide Web, such as a WAP enable cell phone or PDA. The consumer provides personal information sufficient to identify the consumer to the registration system 10. For example, Mr. Jones is male, has a birth date of Oct. 6, 1960, and lives at 789 Lovett Road in Newton Centre, Mass. This information may be entered into his personal computer 50 and transmitted to the registration system 10 through a web site page, as depicted in FIG. 4, which stores the information in a consumer account 22. The system 10, however, could operate with as little information as e-mail address, user ID and password. The registration system 10 then assigns Mr. Jones a consumer identifier 26 which is utilized anytime the consumer's product registrations 24 are is communicated to a third party, such as the product manufacturer, for example. This consumer identifier 26 could be anything including a server 15 assigned consumer number to something which is indicative of the consumer and pseudo-randomly generated such as the initials of the user's name plus the numerical representation of their birth date. For example, consumer Mr. Jones may be assigned consumer identifier 26 MJ100660 which is stored in consumer account 26.

With reference again to FIGS. 2-3, when, for example, consumer Mr. Jones purchases a product, manufactured by a particular manufacturer, such as a camcorder, (A1) Mr. Jones will enter the manufacturer, make, model, serial number and date of purchase into his consumer device 50 (B1, B2, B3) and transmit this information to the registration system 10 (C). This information is then rationalized and stored in a data structure, as described above, in his consumer account 22 in product registration database 20. If it is the first time that he is registering with the system 10 he will also transmit minimal personal information necessary to identify Mr. Jones to the system 10. This information is stored in his consumer account 22. Therefore, when he registers subsequent products he need not re-enter this portion of the information.

Referring again to FIGS. 2-3, when Mr. Jones registers the product with the registration system 10, the server 15 preferably passes the consumer identifier 26 along with any non-personal information corresponding to Mr. Jones and the product registration information 24 from the consumer account 22 to manufacturer (D, although this step is not required). This information includes at a minimum the consumer identifier and the product registration information 24 such as make, model, serial number and date of purchase. Each manufacturer can request different levels of administrative information. For example, if Mr. Jones provided demographic information such as income, age, types of products owned, etc., then this information could also be transmitted to manufacturer in step D whether at time of registration or at a later time with the registration system 10. The Manufacturer may, in turn, elect to receive the minimum information necessary to track products, or may ask for all demographic information within product registration database 20. It should be noted that the registration system 10 and Manufacturer communication directly and, thus, the Manufacturer receives no direct access to the consumer. A manufacturer wishing to communicate with a particular consumer must use that consumer's consumer identifier 26 and transmit a message 34 to the message database 30 or, if opted for by the consumer, send mail electronically or through the postal service directly to the consumer.

By creating a consumer identifier 26 and mapping it to consumer specific information in the consumer account, the registration system 10 acts as a blind between the manufacturer and the consumers. As a result, consumers can feel free to communicate with the manufacturer without fear of being spammed, or loss of privacy. Because these concerns are removed more consumers are likely to register and manufacturers, if they elect to do so, can receive important demographic information such as consumer profiles, to make better business decisions and to better service their consumers by establishing a means for contact without such consumer revealing personally identifying information.

The registration system 10 also preferably creates consumer mailboxes 32 in the message database 30 for each registered consumer. Access to mailboxes 32 is password protected to ensure privacy. All data to be sent to a consumer by third parties including Manufacturers are routed to the consumer's mailbox 32 further minimizing any direct contact with consumers, while strengthening the consumer blind aspect of the process. This also allows the server system 15 to contact a consumer even if consumer has changed physical location (i.e., moved) or e-mail address.

If a manufacturer needs to contact specific consumers, such as Mr. Jones and those who have bought camcorders, for instance, it can do so. For example, if a preventive maintenance alert is to be issued or a recall is to be issued, the manufacturer can identify all of those purchasers of the camcorder by product identifier 21, which are mapped to the product registration information 24 stored in consumer accounts 22, and transmits a message 34 to the message database 30 along with a list of product identifiers 21 created by the registration system 10. The registration system 10 receives the message 34 and matches the consumer identifier 26 to each consumer account 22 having the subject product registration information 24 stored therein and causes the recall, preventive maintenance or other type of information to be sent to those camcorder purchasers who have registered the product with the system 10, either by sending the information to their mailbox 32 in message database 30, by e-mail or in special circumstances where required by law by regular mail.

If as part of the account information Mr. Jones had indicated that he would be willing to receive new product information related to camcorders or any other product, such permission could be stored in his consumer account 22 so that when the manufacturer does a burst mailing of other product information, the registration system 10 can filter that mailing to only go to the consumer mailboxes 32 or in the alternative directly to those consumers which indicated an inclination to receive such information. As described above, the consumer can also opt-in to receive messages directly. The system 10 could also make post-purchase behavior and satisfaction questionnaires and transmit them to consumers to determine their satisfaction and transmit this information back to manufacturers if the respective consumers decide to fill out such a questionnaire.

As consumers register more products, incentives can be offered for using the registration system 10. Additional incentives may be provided if consumers answer manufacturer surveys transmitted by the registration system 10 to consumer device 50 which are unrelated to the specific products purchased by consumers, but are still of interest to manufacturers, such as consumer willingness to buy other products, consumer personal income, age, household members or the like. In a preferred embodiment, the incentives, for example, are to award entries into sweepstakes and to provide an opportunity for consumers to make free charitable contributions to the charity of their choice. For instance, each time a consumer registers a product the consumer will be given the choice to choose from one or more pre-selected charities to donate a certain dollar amount. Of course, the particular charity selected or the dollar amount of the contribution made to the charity is not critical to the present invention. In this way, the consumer is incentivized to register his or her products with the registration system 10. In addition, each time a consumer registers a product, the consumer will receive an entry into a sweepstakes (FIGS. 5-6). Thus, upon completion of the product registration, is asked to select from various prizes being offered in the sweepstakes (FIGS. 5-6). By way of example only, various types of consumer products such as automobiles, home theater systems, home computer systems, to name a few, may be offered to the consumer and the sweepstakes.

The winner may be selected randomly among the entrants who have entered in accordance with contest rules. Therefore, chances of winning may be increased by increasing the number of products registered which provides incentive to register numerous products.

The registration system 10 can track the entrants in the contests and notes which types of products any particular consumer (Mr. Jones) is pursuing. If Jones, for example, is entering for a particular good or class of goods such as children's products, such as strollers, bassinets, cribs, or the like, the registration system 10 will note this. Server 10 may, if the consumer so chooses, transmit the information to the manufacturer (of children's products for example) that the consumer identified by consumer identifier 26 is interested in a particular product. Then the registration system 10 on behalf of the manufacturer can create a rebate code or coupon code using any internal code generating function, such as random number, serial number, or incorporate the consumer identifier 26 and forward that to the registration system 10 with rebate instructions. The registration system 10 then maps the consumer identifier 26 to the rebate or coupon information and transmits the offer to the consumer mailbox 32 in message database 30. Alternatively, if the consumer has opted to receive direct communications, the consumer device 50 can directly receive the offer.

The instructions would include that Jones purchased the product, and provide the offer code along with the make, model, serial number and date of purchase information to the registration system. When Jones purchases the product from a designated online or offline distributor or retailer, to which the manufacturer has already forwarded the product, the distributor or retailer will ship the product to Jones. Jones, in accordance with the instructions, will then register the make, model, serial number and rebate offer code with the registration system 10. This confirms to registration system 10 manufacturer that a sale has been made as a direct response to the rebate. Furthermore, the manufacturer knows non-personally identifiable information about the consumer which made the purchase. In this way it can exactly track the effect of its rebate offer and the use of the registration system 10. Further, one instruction may be to redeem the rebate at a particular distributor or retailer fostering strategic partnerships between distributors or retailers and manufacturers and maintaining a high quality with known distributors or retailer.

Furthermore, incentives can be awarded for providing consumer satisfaction information post-purchase so that consumers are not required to provide this information, but in order to earn the incentive, it is in their interest to provide some or all of the information.

With reference to FIGS. 1, 3 and 9, the registration system 10 is preferably linked to both repair and service organizations and secondary market systems 125. Throughout the life of a product, a consumer will preferably utilize the provided repair links to service his/her registered products. By way of example only, a consumer can link to a repair shop that specializes in the particular product sought to be registered. In this fashion, the consumer can schedule to bring the product in for maintenance or repair. During this process, the repair shop system is provided a product ID 21 or the consumer ID 26 for the subject product. This will enable the repair shop to prepare a report of the service, which will be communicated back to the registration system 10 and stored in the product registration database 20 in a repair data file 28. The repair data file 28 is associated with the particular product registration 24 for which the service has been performed. Using the repair data file 28, various reports can be generated and communicated to manufacturers desiring to collect data regarding the operation of its products. Moreover, as described below the repair data files 28 may be used to provide buyers of used products otherwise unavailable product information.

As noted above, the registration system 10 is preferably linked to secondary market systems 125 such as, for example, online auction sites, swap sites, and other used product sales organizations. When a consumer wishes to sell a registered product, the consumer can link to such a secondary market system 125 to place the product on sale. For example, link 902 directs the consumer to an online auctioneer, by way of non-limiting example, to offer the product for sale. If the product is placed on sale, the registration system 10 communicates the repair data 28 associated with the product to the secondary market system 125. Thus, consumers are given access to valuable historical information with respect to the operation of the product for sale. In this way, the sale of defective used products is prevented and uncertainty associated with the purchase of a used product is removed, which may actually increase the offered price for the used product. In addition to repair data 28, any other type of product data, by way of non-limiting example effective warranty terms, can be associated and stored with the product registration information 24.

The account summary page 910 may also include a field 915 for importing prices for the products relating to the product registration information 24 from the secondary market systems 125. Prices from recent sales, for instance, of similar products on the secondary market systems 125 may be communicated to and imported into field 915 to indicate such recent prices to the consumer. This field can also serve as a valuation indicator for insurance purposes.

In an alternate embodiment of the present invention, a consumer is offered the option to remove the blind feature of the present invention so that third parties, such as manufactures, could communicate directly with the consumer.

One skilled in the art will recognize that the centralized product registration system of the present invention may be electronically linked to any number of information sources and service organizations that provide product information or services, respectively, to facilitate the centralized collection and distribution of product registration information in a consumer blind fashion.

Thus, while there have been shown and described and pointed out fundamental novel features of the invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

We claim:

1. A method of collecting product registration information from a consumer, comprising:
receiving consumer information from a consumer;
receiving the product registration information from the consumer;
associating the consumer information with the product registration information; and
making at least a portion of the product registration information available to third parties, while not making the consumer information available.

2. The method of claim 1, further comprising, after the consumer information is received, associating the consumer information with a unique consumer identifier and wherein the step of associating the consumer information with the product registration information comprises associating the unique consumer identifier with the product registration information.

3. The method of claim 2, wherein at least a portion of the product registration information is made available along with only the unique consumer identifier, such that no consumer information is made available.

4. The method of claim 1, wherein the product registration information is received via a registration postcard.

5. The method of claim 1, wherein the product registration information is received electronically.

6. The method of claim 5, wherein the product registration information is received through use of a consumer device.

7. The method of claim 6, wherein the consumer device is a personal computer and the product registration information is input to and transferred via a communications network.

8. The method of claim 6, wherein the consumer device is a personal digital assistant and the product registration information is input to and transferred via a communications network.

9. The method of claim 6, wherein the consumer device is a wireless device and the product registration information is input to and transferred via a communications network.

10. The method of claim 6, wherein the consumer device electronically uploads the product registration information and transfers the product registration information via a communication network.

11. The method of claim 10, wherein the consumer device is WAP enabled.

12. The method of claim 10, wherein the consumer device scans a bar-code including at least a portion of the product registration information.

13. The method of claim 10, wherein the consumer device receives a radio frequency signal including at least a portion of the product registration information.

14. The method of claim 10, wherein the consumer device is a smart card.

15. The method of claim 1, further comprising receiving a product notice and matching the product notice to the product registration information for which the product notice corresponds.

16. The method of claim 15, further comprising notifying the consumer of the product notice matched to the product registration information.

17. The method of claim 1, wherein the third party is a manufacturer and further comprising communicating the product registration information to the manufacturer along with the corresponding unique consumer identifier, such that the consumer's actual identity is not revealed to the manufacturer.

18. The method of claim 1, wherein the third party is a service organization.

19. The method of claim 18, wherein the service organization is a product repair shop.

20. The method of claim 1, wherein the third party is a secondary market system.

21. The method of claim 20, wherein the secondary market system is an online auctioneer, such that the consumers can offer registered products for sale.

22. The method of claim 20, wherein the secondary market system is an online product swap site, such that the consumers can trade registered products.

23. The method of claim 1, further comprising receiving messages from the third parties into mailboxes, each of the mailboxes associated with one of the consumers and the messages being electronically retrievable by the consumers.

24. The method of claim 23, wherein at least one of the messages is a warranty notification.

25. The method of claim 23, wherein at least one of the messages is a product offer.

26. The method of claim 23, wherein at least one of the messages is a rebate offer.

27. A centralized product registration system, comprising:
a server system including:
a processor;
a product registration database having stored thereon a unique consumer account comprising personal information about a consumer, the product registration database also having stored therein product registration information, the consumer account being associated with a unique consumer identifier; and
wherein the processor is programmed to receive the product registration information from the consumer, store the product registration information in the consumer account associated with the consumer identifier, and whereby the consumer's actual identity is kept anonymous by stripping the consumer's personal information from the unique consumer identifier and product registration information.

28. The registration system of claim 27, wherein the unique consumer identifier is devoid of any of the consumer's personal information, and wherein the server system maintains anonymity by communicating only the unique consumer identifier associated with the consumer account to third parties.

29. The registration system of claim 27, wherein the product registration information is received via a registration postcard.

30. The registration system of claim 27, wherein the product registration information is received electronically.

31. The registration system of claim 30, wherein the product registration information is received through use of a consumer device.

32. The registration system of claim 31, wherein the consumer device is a personal computer and the product registration information is input to and transferred via a communications network.

33. The registration system of claim 31, wherein the consumer device is a personal data assistant and the product registration information is input to and transferred via a communications network.

34. The registration system of claim 30, wherein the consumer device is a wireless device and the product registration information is input to and transferred via a communications network.

35. The registration system of claim 30, wherein the consumer device electronically uploads the product registration information and transfers the product registration information via a communication network.

36. The registration system of claim 35, wherein the consumer device is WAP enabled.

37. The registration system of claim 35, wherein the consumer device scans a bar-code including at least a portion of the product registration information.

38. The registration system of claim 35, wherein the consumer device receives a radio frequency signal including at least a portion of the product registration information.

39. The registration system of claim 35, wherein the consumer device is a smart card.

40. The registration system of claim 27, wherein the server system is programmed to receive a product notice and the server system further includes a product notice database for storing the product notice thereon.

41. The registration system of claim 40, wherein the server system is programmed to match the product notice to the product registration information for which the product notice pertains.

42. The registration system of claim 41, wherein the server system is programmed to notify the consumer the product notice matched to the product registration information stored in the consumer's consumer account.

43. The registration system of claim 40, wherein the product notice is a product recall notices.

44. The registration system of claim 40, wherein the product notice is a safety notices.

45. The registration system of claim 40, wherein the product notice is a general product information notice.

46. The registration system of claim 27, wherein the server system is programmed to receive messages and the server system further includes a message database for storing the messages in an electronic mailbox associated with the unique consumer identifier, such that the consumer's actual identity is not revealed.

47. The registration system of claim 46, wherein the messages are accessible to the consumers via a communications network.

48. The registration system of claim 46, wherein at least one of the messages is a warranty notification.

49. The registration system of claim 46, wherein at least one of the messages is a product offer.

50. The registration system of claim 46, wherein at least one of the messages is a rebate offer.

51. The registration system of claim 27, wherein the server system is communicatively connected to a service organization.

52. The registration system of claim 51, wherein the service organization is a product repair shop.

53. The registration system of claim 27, wherein the server system is communicatively connected to a secondary market system enabling the consumer to offer product for sale.

54. The registration system of claim 53, wherein the secondary market system is an online auctioneer.

55. The registration system of claim 53, wherein the secondary market system is an online product swap site.

56. A centralized product registration system, comprising:
a server system interconnected to consumers and a plurality of third party information sources via a communications network, the server system including;
a product registration database for storing product registration information received from a consumer in a consumer account;
a first database for storing a product notice received from one third party of the plurality of information sources; and
a processor operative with software to notify consumers of the product notices and anonymously distribute the product registrations via the communications network.

57. The registration system of claim 56, further comprising a second database for storing a message received from one third party of the plurality of information sources.

58. The registration system of claim 56, wherein one third party of the plurality is a manufacturer of a product corresponding to the product registration information.

59. The registration system of claim 56, wherein one third party of the plurality is a product safety organization.

60. The registration system of claim 56, wherein one third party of the plurality is a service organization.

61. The registration system of claim 56, wherein one third party of the plurality is an online auctioneer.

62. The registration system of claim 56, wherein one third party of the plurality is a used product merchant.

63. A method of centrally collecting consumer product information from a variety of sources, comprising:
linking a registration system to a communications network;
receiving the product information through the communications network;
matching the product information to product registrations stored in consumer accounts on the registration system;
identifying the product registrations by unique consumer identifiers so that the product registrations can be communicated anonymously.
